(19) United States
(12) Patent Application Publication
(10) Pub. No.: US 2026/0214322 A1
(43) Pub. Date: Jul. 23, 2026

(54) IMAGING DEVICE, IMAGING CONTROL METHOD, AND IMAGING CONTROL PROGRAM

(71) Applicant: TOYOTA JIDOSHA KABUSHIKI KAISHA, Aichi-ken (JP)

(72) Inventor: Satoshi NAITO, Yokohama-shi (JP)

(21) Appl. No.: 19/454,257

(22) Filed: Jan. 20, 2026

(30) Foreign Application Priority Data
Jan. 23, 2025 (JP) 2025-009764

(51) Int. Cl. H04N 23/60; H04N 23/20; H04N 23/56; H04N 23/611; H04N 23/72; H04N 23/73; H04N 23/74; H04N 23/90

(52) U.S. Cl. CPC H04N 23/64; H04N 23/20; H04N 23/56; H04N 23/611; H04N 23/72; H04N 23/73; H04N 23/74; H04N 23/90

(57) ABSTRACT

An imaging device includes: first and second cameras having sensitivity to invisible light; first and second irradiation unit configured to irradiate imaging ranges of the first and second camera with the invisible light, respectively; and a control unit configured to control the cameras and the irradiation units. An image captured by the first camera has a higher acquisition priority than an image captured by the second camera. The control unit is configured to perform control such that, in a unit imaging cycle, a first irradiation/exposure period by the first irradiation unit and first camera and a second irradiation/exposure period by the second irradiation unit and the second camera do not overlap each other, and the first irradiation/exposure period is changed according to a value of a dynamic range in the image captured by the first camera.

### FIELD

The present disclosure relates to an imaging device, an imaging control method, and an imaging control program.

### BACKGROUND

In the related art, there has been known an imaging system that includes a plurality of infrared camera modules that perform imaging after irradiation of infrared light and performs imaging at the same timing by the infrared camera modules (JP 6743708 B). In particular, in the imaging system described in Patent Document 1, in order to suppress deterioration of image quality caused by simultaneously performing irradiation of the infrared light from the infrared camera modules located close to each other for imaging by the infrared camera modules, imaging is performed at different timings in the infrared camera modules.

In the imaging system described in JP 6743708 B, the timings of irradiation with the infrared light are shifted in the plurality of infrared camera modules, and thus imaging by the plurality of infrared camera modules is sequentially performed. As a result, an imaging cycle becomes long.

On the other hand, when the imaging cycle is set short, an exposure time for imaging in the infrared camera module becomes short. As a result, imaging with sufficient exposure cannot be performed, and the image quality of the captured image may be deteriorated.

In view of the above problem, an object of the present disclosure is to suppress the influence of the deterioration in the image quality due to a shortage of the exposure time to a low level while suppressing the deterioration in the image quality due to overlapping of irradiation timings.

### SUMMARY

The present disclosure includes the following aspects.
(1) An imaging device configured to perform imaging, comprising:
   a first camera and a second camera each having sensitivity to invisible light;
   a first irradiation unit configured to irradiate an imaging range of the first camera with the invisible light during an exposure period in the first camera;
   a second irradiation unit configured to irradiate an imaging range of the second camera with the invisible light during an exposure period in the second camera; and
   a control unit configured to control the first camera, the second camera, the first irradiation unit, and the second irradiation unit, wherein
   an irradiation range of the invisible light by the first irradiation unit at least partially overlaps an irradiation range of the invisible light by the second irradiation unit,
   an image captured by the first camera has a higher acquisition priority than an image captured by the second camera, and
   the control unit is configured to perform control such that, in a unit imaging cycle, a first irradiation/exposure period in which irradiation by the first irradiation unit and exposure by the first camera are performed and a second irradiation/exposure period in which irradiation by the second irradiation unit and exposure by the second camera are performed do not overlap each other, and the first irradiation/exposure period in the unit imaging cycle is changed according to a value of a first parameter that changes according to ease of recognition of an object in the image captured by the first camera.
(2) The imaging device according to above (1), wherein
   the control unit is configured to perform control such that, in the unit imaging cycle, the first irradiation/exposure period is made equal to or greater than the second irradiation/exposure period according to the value of the first parameter.
(3) The imaging device according to above (2), wherein
   the control unit is configured to perform control such that as the value of the first parameter indicates higher difficulty in recognizing an object in the image captured by the first camera, the first irradiation/exposure period is made correspondingly longer than the second irradiation/exposure period.
(4) The imaging device according to above (3), wherein
   the first parameter is a dynamic range in the image captured by the first camera, and
   the control unit is configured to perform control such that as the value of the dynamic range is lower, the first irradiation/exposure period is made correspondingly longer than the second irradiation/exposure period.
(5) The imaging device according to any one of claims (1) to (4), wherein
   the control unit is configured to perform control such that start of the first irradiation/exposure period is repeated at the same time interval regardless of a change in the first irradiation/exposure period or the second irradiation/exposure period in the unit imaging cycle.
(6) The imaging device according to any one of claims (1) to (5), wherein
   the control unit is configured to cancel the exposure in the second camera and the irradiation by the second irradiation unit when the value of the first parameter is a value indicating that the ease of recognition of an object in the image captured by the first camera is equal to or less than a predetermined first ease of recognition.
(7) The imaging device according to any one of claims (1) to (6), wherein
   the control unit is configured to perform control such that the second irradiation/exposure period is longer than the first irradiation/exposure period, in a proportion of imaging cycles less than half among consecutive imaging cycles of the first camera and the second camera, when a value of a second parameter that changes according to ease of recognition of an object in the image captured by the second camera is a value indicating that the ease of recognition of an object in the image captured by the second camera is equal to or less than a predetermined second ease of recognition.
(8) The imaging device according to any one of claims (1) to (7), wherein
   the invisible light is infrared light.
(9) The imaging device according to any one of claims (1) to (8), wherein
   the imaging device is equipped on one vehicle.
(10) The imaging device according to above (9), wherein
   the image captured by the first camera is used for a function related to safety of a passenger of the vehicle more than the image captured by the second camera is.
(11) The imaging device according to above (9) or (10), wherein
   the first camera and the second camera are disposed to image the same passenger of the vehicle.
(12) An imaging control method for controlling a first camera and a second camera each having sensitivity to invisible light, a first irradiation unit configured to irradiate an imaging range of the first camera with the invisible light during an exposure period in the first camera, and a second irradiation unit configured to irradiate an imaging range of the second camera with the invisible light during an exposure period in the second camera, wherein
   an irradiation range of the invisible light by the first irradiation unit at least partially overlaps an irradiation range of the invisible light by the second irradiation unit,
   an image captured by the first camera has a higher acquisition priority than an image captured by the second camera, and
   the imaging control method comprises controlling the first camera, the second camera, the first irradiation unit, and the second irradiation unit such that, in a unit imaging cycle, a first irradiation/exposure period in which irradiation by the first irradiation unit and exposure by the first camera are performed and a second irradiation/exposure period in which irradiation by the second irradiation unit and exposure by the second camera are performed do not overlap each other, and the first irradiation/exposure period in the unit imaging cycle is changed according to a value of a first parameter that changes according to ease of recognition of an object in the image captured by the first camera.
(13) An imaging control program configured to control a first camera and a second camera each having sensitivity to invisible light, a first irradiation unit configured to irradiate an imaging range of the first camera with the invisible light during an exposure period in the first camera, and a second irradiation unit configured to irradiate an imaging range of the second camera with the invisible light during an exposure period in the second camera, wherein
   an irradiation range of the invisible light by the first irradiation unit at least partially overlaps an irradiation range of the invisible light by the second irradiation unit,
   an image captured by the first camera has a higher acquisition priority than an image captured by the second camera, and
   the imaging control program causes a computer to execute control of the first camera, the second camera, the first irradiation unit, and the second irradiation unit such that, in a unit imaging cycle, a first irradiation/exposure period in which irradiation by the first irradiation unit and exposure by the first camera are performed and a second irradiation/exposure period in which irradiation by the second irradiation unit and exposure by the second camera are performed do not overlap each other, and the first irradiation/exposure period in the unit imaging cycle is changed according to a value of a first parameter that changes according to ease of recognition of an object in the image captured by the first camera.

### BRIEF DESCRIPTION OF DRAWINGS

FIG. 1 is a configuration diagram schematically illustrating a configuration of an imaging device.

FIG. 2 is a schematic side view partially illustrating an interior of a vehicle equipped with the imaging device.

FIG. 3 is a functional block diagram of a processor of a control device.

FIG. 4 is a time chart of basic control showing an irradiation timing of infrared light by a first projector and the like.

FIG. 5 is a time chart, similar to FIG. 4, of the control of an irradiation/exposure period according to a first embodiment.

FIG. 6 is a flowchart showing a flow of setting processing of an irradiation/exposure period executed by an imaging control unit.

FIG. 7 is a time chart, similar to FIG. 5, of the control of the irradiation/exposure period according to a second embodiment.

### DESCRIPTION OF EMBODIMENTS

Hereinafter, embodiments will be described in detail with reference to the drawings. In the following description, similar components are denoted by the same reference numerals.

### First Embodiment

### Configuration of Imaging Device

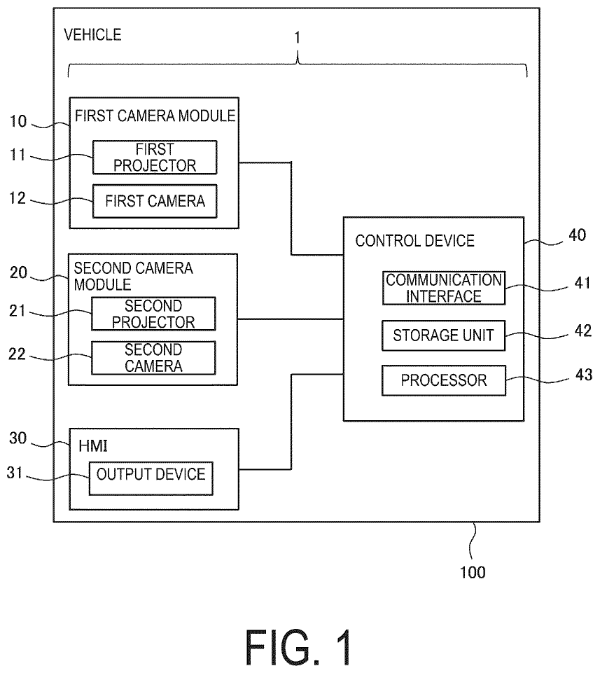

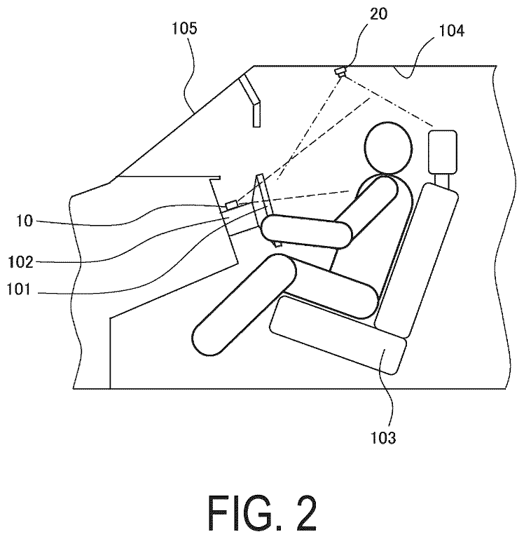

First, a configuration of an imaging device 1 according to a first embodiment will be described with reference to FIGS. 1 and 2. FIG. 1 is a configuration diagram schematically illustrating a configuration of an imaging device 1 according to a first embodiment. FIG. 2 is a schematic side view partially illustrating an interior of a vehicle 100 equipped with the imaging device 1. The imaging device 1 is equipped on one vehicle 100 and performs imaging of an object in the vehicle 100. In the present embodiment, the imaging device 1 images the object in the vehicle 100, for example, a passenger of the vehicle 100, by a plurality of cameras whose imaging ranges at least partially overlap each other.

In the present embodiment, the imaging device 1 includes a first camera module 10, a second camera module 20, a human-machine interface (HMI) 30, and a control device 40. The first camera module 10, the second camera module 20, and the HMI 30 are connected to the control device 40 via signal lines.

The first camera module 10 images a driver (particularly, a face of the driver) for the main purpose of detecting a face direction, a line-of-sight direction, an open/closed state of eyes, and the like of the driver of the vehicle 100. In the present embodiment, as illustrated in FIG. 2, the first camera module 10 is disposed on an upper portion of a steering column 102 so as to face the face of the driver. The first camera module 10 may be disposed on a steering wheel 101, a room mirror, a meter panel, a meter hood, or the like as long as the first camera module 10 can image the face of the driver.

The first camera module 10 includes a first projector 11 and a first camera 12. In the present embodiment, the first projector 11 and the first camera 12 are integrally configured as the first camera module 10, but the first projector 11 and the first camera 12 may be separately disposed as separate devices.

The first projector 11 is an example of a first irradiation unit that irradiates an imaging range of the first camera 12 with infrared light. In the present embodiment, the first projector 11 emits the infrared light of a predetermined wavelength (for example, 850 nm or 940 nm) during an exposure period in the first camera 12. The first projector 11 includes an infrared light emitting diode that emits the infrared light. The first projector 11 performs irradiation of the infrared light according to a signal from the control device 40.

The first camera 12 is a camera having sensitivity to the infrared light, and receives reflected light of the infrared light emitted from the first projector 11 and reflected by a subject, and performs imaging. The first camera 12 transmits the imaged image to the control device 40. The first camera 12 includes an image sensor (for example, a complementary metal oxide semiconductor (CMOS) image sensor or a charge coupled device (CCD) image sensor), a filter that transmits the infrared light, and an imaging optical system that forms an image of a region to be imaged on a photoelectric conversion element (for example, a photodiode) of the image sensor.

The image sensor of the first camera 12 includes a photoelectric conversion element such as a photodiode and a capacitor. In particular, the image sensor includes a plurality of the photoelectric conversion elements arranged in a two dimensional array and a plurality of the capacitors corresponding to the respective photoelectric conversion elements.

When the photoelectric conversion element receives light, the photoelectric conversion element generates charges corresponding to an intensity of the received light, and the capacitor accumulates the charges generated in the photoelectric conversion element. In the present embodiment, since the filter is disposed in front of the image sensor, the photoelectric conversion element generates the charges corresponding to the intensity of infrared light. The first camera 12 can change an exposure period that is a period in which the charges accumulated in the capacitor are generated in the photoelectric conversion element by irradiating the photoelectric conversion element with the light. In the present specification, the generation of the charges accumulated in the capacitor in the photoelectric conversion element by irradiating the photoelectric conversion element with light is referred to as exposure in the camera.

The capacitor accumulates the charges generated in the photoelectric conversion element during the exposure period, and the charges accumulated in the capacitor are transferred after completion of the exposure period. The intensity of light received by the photoelectric conversion element corresponding to each pixel is detected according to the amount of the charges transferred in this manner. In the present specification, such transfer of the charges from the capacitor is referred to as readout in the camera.

The second camera module 20 images a seat 103 (or a region including a hand of a passenger (a driver and an occupant on a passenger seat) seated on the seat 103) from above for the main purpose of detecting a movement (for example, an operation of a navigation device, and a pointing movement) of the hand of the passenger seated on the seat 103 (including the passenger seat) of the vehicle 100. As illustrated in FIG. 2, the second camera module 20 is disposed on a ceiling 104 of the vehicle 100 so as to face the seat 103. Thus, the face of the driver is included in an imaging range of the second camera module 20, and thus an imaging range of the first camera module 10 and the imaging range of the second camera module 20 partially overlap each other. In particular, in the present embodiment, the first camera module 10 and the second camera module 20 are disposed so as to image the same passenger (driver). The second camera module 20 may be disposed on an upper portion of a front window 105 or the like as long as the second camera module 20 can image the seat 103 from above.

The second camera module 20 also includes a second projector 21 and a second camera 22, similarly to the first camera module 10. In the present embodiment, the second projector 21 and the second camera 22 are integrally configured as the second camera module 20, but the second projector 21 and the second camera 22 may be separately disposed as separate devices.

The second projector 21 is an example of a second irradiation unit that irradiates an imaging range of the second camera 22 with the infrared light. The second projector 21 has a configuration similar to that of the first projector 11. Thus, during the exposure period of the second camera 22, the second projector 21 emits the infrared light having the same or substantially the same wavelength as the infrared light emitted by the first projector 11.

The second camera 22 is a camera having sensitivity to the infrared light, and receives reflected light of the infrared light emitted from the second projector 21 and reflected by a subject, and performs imaging. The second camera 22 also transmits the imaged image to the control device 40. The second camera 22 also has a configuration similar to that of the first camera 12, and includes an image sensor, a filter, and an imaging optical system.

The first camera module 10 and the second camera module 20 may be used for purposes different from the above-described purposes. For example, the second camera module 20 may be used for the main purpose of detecting a wearing/unwearing state of the seat belt of the passenger seated on each seat of the vehicle 100. Alternatively, the second camera module 20 may be used for the main purpose of detecting an operation of a smartphone by the driver of the vehicle 100.

In addition, the first camera module 10 and the second camera module 20 may be disposed at positions different from the above-described positions. For example, both the first camera module 10 and the second camera module 20 may be disposed on the ceiling 104 so as to image the sheet 103 from above at different angles. In this case, for example, one camera module is used for the main purpose of detecting the wearing/unwearing state of the seat belt of the passenger, and the other camera module is used for the main purpose of detecting the movement of the hand of the passenger.

However, in any case, the first camera module 10 and the second camera module 20 are disposed such that the imaging range of the first camera 12 and the imaging range of the second camera 22 at least partially overlap each other. Thus, in either case, the first camera module 10 and the second camera module 20 are disposed such that the irradiation range of the infrared light by the first projector 11 and the irradiation range of the infrared light by the second projector 21 at least partially overlap each other.

Further, the first projector 11 and the second projector 21 project the infrared light, but may project invisible light other than the infrared light. The first camera 12 and the second camera 22 may be cameras having sensitivity to the invisible light other than the infrared light.

In the present embodiment, the imaging device 1 includes two camera modules, namely, the first camera module 10 and the second camera module 20. However, the imaging device 1 may include three or more camera modules. In this case, for each of the plurality of camera modules, the imaging range of each camera at least partially overlaps the imaging range of another camera, and thus the irradiation range of the infrared light by each projector at least partially overlaps the irradiation range of the infrared light by another projector.

The HMI 30 is a user interface for exchanging information between the vehicle 100 and the passenger of the vehicle 100. The HMI 30 includes an output device 31 for notifying the passenger through a body sensation (for example, a sense of sight, a sense of hearing, and a sense of touch) of the passenger. The output device 31 is, for example, displays (for example, a meter display, a center display, and a head-up display), a speaker, and a vibrating body. For example, in the control device 40, when inattentiveness or drowsiness of the driver is detected based on the image imaged by the first camera 12, a warning is issued to the passenger by the output device 31.

### Configuration of Control Device

The control device 40 controls the first camera module 10 (the first projector 11 and the first camera 12), the second camera module 20 (the second projector 21 and the second camera 22), and the HMI 30. In the present embodiment, the control device 40 controls a timing of irradiation start and irradiation time by the projectors 11 and 21 of both camera modules, that is, controls the irradiation period by the projectors 11 and 21. The control device 40 controls a timing of exposure start and the exposure time by the cameras 12 and 22 of both camera modules, that is, controls the exposure period in the cameras 12 and 22. In addition, the control device 40 controls notification to the passenger by the output device 31 of the HMI 30.

The control device 40 includes a communication interface 41, a storage unit 42, and a processor 43. The communication interface 41, the storage unit 42, and the processor 43 may be configured as separate circuits or may be configured as a single integrated circuit such as a system on a chip (SoC).

The communication interface 41 includes an interface circuit for connecting the control device 40 to other devices such as the first camera module 10. The control device 40 is connected to other devices via the communication interface 41. The communication interface 41 transmits data representing the imaged images received from the first camera module 10 and the second camera module 20 to the processor 43. The communication interface 41 transmits a signal output from the processor 43 to the first camera module 10, the second camera module 20, and the output device 31 of the HMI 30.

The storage unit 42 is a device that stores data, and is a non-transitory storage medium. The storage unit 42 includes, for example, a volatile semiconductor memory (for example, a dynamic random access memory (DRAM) and a static random access memory (SRAM)) and a nonvolatile semiconductor memory (for example, a read only memory (ROM), an electrically erasable programmable read only memory (EEPROM), and a flash memory). The storage unit 42 may include a hard disk drive (HDD) and a solid state drive (SSD). The storage unit 42 stores a computer program executed by the processor 43. The storage unit 42 stores data and the like representing images imaged by the first camera 12 and the second camera 22.

The processor 43 includes one or a plurality of CPUs (Central Processing Units) and a peripheral circuit thereof. The processor 43 may further include another operation circuit such as a logic operation unit, an arithmetic logic unit, or a graphics processor unit. The processor 43 executes the computer program stored in the storage unit 42.

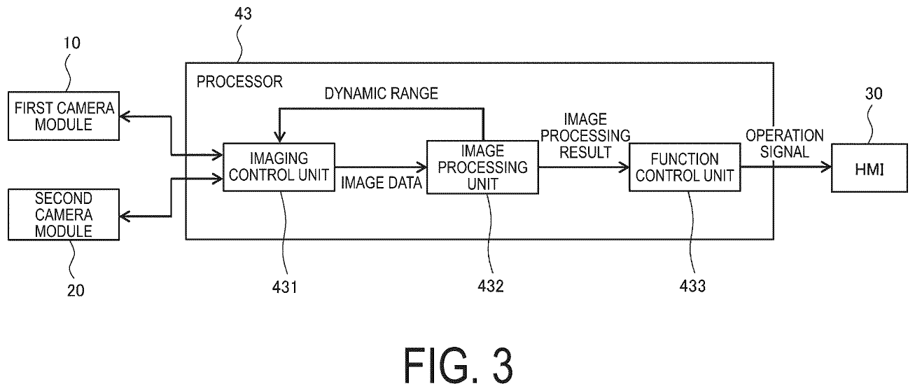

FIG. 3 is a functional block diagram of the processor 43 of the control device 40. As illustrated in FIG. 3, the processor 43 includes an imaging control unit 431, an image processing unit 432, and a function control unit 433. These units included in the processor 43 are, for example, functional modules executed by the computer program operating on the processor 43. Alternatively, these units included in the processor 43 may be mounted to the control device 40 as independent integrated circuits, microprocessors, or firmware.

The imaging control unit 431 controls the camera modules 10 and 20. The imaging control unit 431 transmits an exposure start signal to each of the camera modules 10 and 20 at a timing to start the exposure to the infrared light and the visible light in the corresponding cameras 12 and 22. The imaging control unit 431 transmits an irradiation start signal to each of the camera modules 10 and 20 at a timing to start the irradiation of the infrared light by the corresponding projectors 11 and 21.

In the present embodiment, since the exposure in the first camera 12 and the irradiation with the infrared light by the first projector 11 are simultaneously performed, the exposure start signal and the irradiation start signal to the first camera module 10 are integrated into one signal. In addition, in the present embodiment, since the exposure in the second camera 22 and the irradiation with the infrared light by the second projector 21 are simultaneously performed, the exposure start signal and the irradiation start signal to the second camera module 20 are integrated into one signal.

In the present embodiment, the exposure start signal includes a signal indicating the exposure times in the corresponding cameras 12 and 22. Similarly, in the present embodiment, the irradiation start signal includes a signal indicating the irradiation time for the infrared light by the corresponding projectors 11 and 21. Note that the signals indicating the exposure time and the irradiation time may be transmitted separately from the exposure start signal and the irradiation start signal, respectively.

When the first camera module 10 receives the exposure start signal from the imaging control unit 431, the first camera module 10 starts the exposure in the first camera 12, and then, when a time according to the signal indicating an exposure time included in the exposure start signal elapses, the first camera module 10 ends the exposure in the first camera 12. Further, when the first camera module 10 receives the irradiation start signal from the imaging control unit 431, the first camera module 10 starts the irradiation with the infrared light by the first projector 11, and then, when a time according to the signal indicating an irradiation time included in the irradiation start signal elapses, the first camera module 10 ends the irradiation with the infrared light by the first projector 11. Similarly, the second camera module 20 also controls the exposure in the second camera 22 and the irradiation with the infrared light by the second projector 21.

The imaging control unit 431 receives, from the camera modules 10 and 20, data (image data) representing the infrared light image and the visible light image imaged by the cameras 12 and 22 of the camera modules 10 and 20. When the imaging control unit 431 receives the image data, the imaging control unit 431 transmits the received image data to the image processing unit 432. The image processing unit 432 may directly receive the image data from each of the camera modules 10 and 20.

The image processing unit 432 performs image processing on an image represented by the received image data. In the present embodiment, the image processing performed by the image processing unit 432 includes detecting dynamic ranges in the images captured by the first camera 12 and the second camera 22. The dynamic range is a parameter that changes according to ease of recognition of an object in an image, and the larger the dynamic range, the clearer the contrast in the image, and the easier it is to recognize the object in the image. In this way, by using the dynamic range as a parameter that changes according to the ease of recognition of an object in the image, the ease of recognition of an object can be appropriately detected. The image processing unit 432 transmits a detected value of the dynamic range to the imaging control unit 431.

The image processing unit 432 may detect a parameter other than the dynamic range as long as the parameter changes according to the ease of recognition of an object in the images captured by the first camera 12 and the second camera 22. Thus, the image processing unit 432 may detect, for example, the contrast of the image. Alternatively, the image processing unit 432 may detect a change in the number of recognized objects between frames. In this case, for example, when the proportion of the objects recognized in the previous frame but not recognized in the current frame is large, the image suddenly becomes rough, and thus it is determined that it has become difficult to recognize an object in the image.

In the present embodiment, the image processing unit 432 analyzes the image including the face of the driver imaged by the first camera 12 and detects the face direction, the line-of-sight direction, a degree of eye opening of the eyes, and the like of the driver. The detection of the face direction of the driver and the like is performed by any image processing method such as using a learned machine learning model. In the present embodiment, the image processing unit 432 analyzes an image of the surroundings of each seat 103 imaged by the second camera 22, and detects the movement of the hand of the passenger seated on each seat 103. The detection of the movement of the hand of the passenger is also performed by any image processing method such as using the learned machine learning model. The image processing unit 432 transmits data representing the detected face direction of the driver and the like and data representing the movement of the hand of the passenger to the function control unit 433.

The function control unit 433 controls a function of the vehicle 100 based on the data representing the result of the image processing received from the image processing unit 432.

In the present embodiment, the function control unit 433 detects inattentiveness or drowsiness of the driver based on the face direction, the line-of-sight direction, and the degree of eye opening of the eyes of the driver transmitted from the image processing unit 432, and controls the HMI 30 according to the detection result. For example, when the inattentiveness or drowsiness of the driver is detected, the function control unit 433 transmits a signal instructing the output device 31 of the HMI 30 to execute a warning to the passenger.

In the present embodiment, the function control unit 433 detects whether the operation of the navigation device or the pointing movement by the passenger is performed based on the data representing the movement of the hand of the passenger transmitted from the image processing unit 432, and controls the HMI 30 according to the detection result. For example, when the pointing movement by the passenger is detected, the function control unit 433 searches for a shop or the like present in a pointing direction of the passenger, and transmits a signal for instructing the output device 31 of the HMI 30 to execute notification of information of the searched shop or the like to the passenger.

### Basic Control in Control Device

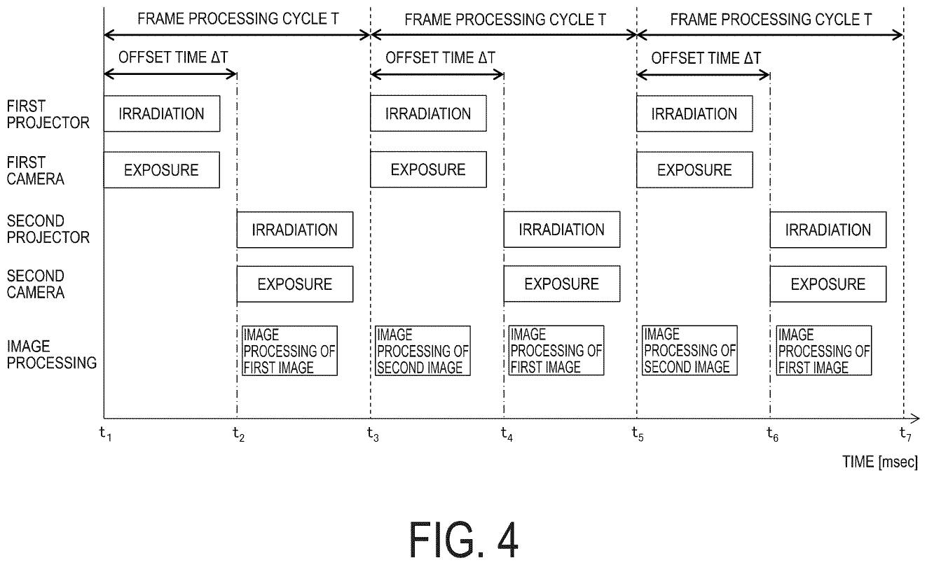

Next, basic control of the first camera module 10 and the second camera module 20 by the control device 40 will be described with reference to FIG. 4. In particular, in the following, control of the first projector 11, the first camera 12, the second projector 21, and the second camera 22 by the imaging control unit 431 will be described.

When the exposure in the first camera 12 and the exposure in the second camera 22 are simultaneously performed, the irradiation of the infrared light by the first projector 11 and the irradiation of the infrared light by the second projector 21 are simultaneously performed. On the other hand, as described above, the imaging range of the first camera 12 and the imaging range of the second camera 22 partially overlap each other, and thus the irradiation range of the infrared light by the first projector 11 and the irradiation range of the infrared light by the second projector 21 partially overlap each other. Thus, when the irradiation of the infrared light from the first projector 11 and the irradiation of the infrared light from the second projector 21 are simultaneously performed, the quality of images imaged by the first camera 12 and the second camera 22 may deteriorate (for example, halation, and formation of unnecessary shadows) in the region where the irradiation of the infrared light from the first projector 11 and the irradiation of the infrared light from the second projector 21 overlap each other. In particular, in the present embodiment, the first camera 12 and the second camera 22 are disposed so as to image the same passenger (driver), and deterioration of image quality may occur in a portion that is most necessary in the control of the vehicle 100.

Thus, in the present embodiment, in each piece of frame processing performed in each frame processing cycle T, the imaging control unit 431 controls the camera modules 10 and 20 so that a first irradiation/exposure period, which is a period in which the irradiation of the infrared light by the first projector 11 and the exposure in the first camera 12 are performed, does not overlap a second irradiation/exposure period, which is a period in which the irradiation of the infrared light by the second projector 21 and the exposure in the second camera 22 are performed. Below, such control by the imaging control unit 431 will be explained with reference to FIG. 4.

FIG. 4 is a time chart of basic control showing an irradiation timing of the infrared light by the first projector 11, an exposure timing in the first camera 12, an irradiation timing of the infrared light by the second projector 21, an exposure timing in the second camera 22, and an execution period of the image processing executed by the image processing unit 432.

As illustrated in FIG. 4, in the present embodiment, the frame processing is performed at an arbitrary frame processing cycle T (for example, several tens [ms] to several hundreds [ms]), and thus imaging by the camera modules 10 and 20 is performed at every frame processing cycle T. In the example shown in FIG. 4, at a time t₁, which is a start timing of the frame processing, the first camera module 10 receives the irradiation start signal and the exposure start signal from the imaging control unit 431, and the irradiation with the infrared light by the first projector 11 and the exposure in the first camera 12 are started.

The irradiation with the infrared light by the first projector 11 is performed over the irradiation time included in the irradiation start signal. Similarly, the exposure in the first camera 12 is also performed over the exposure time included in the exposure start signal. In the present embodiment, the imaging control unit 431 simultaneously transmits the irradiation start signal and the exposure start signal (or transmits the signals as one signal for instruction of the start of both) and the irradiation time and the exposure time are the same time. Thus, in the present embodiment, the period in which the irradiation with the infrared light is performed by the first projector 11 and the period in which the exposure in the first camera 12 is performed are the same period, and these periods are collectively referred to as the first irradiation/exposure period hereinafter. Note that the period in which the irradiation with the infrared light is performed by the first projector 11 and the period in which the exposure in the first camera 12 is performed need not to be the same period, and in this case, the first irradiation/exposure period means a period in which the irradiation with the infrared light by the first projector 11 is performed (usually, longer than the period in which the exposure in the first camera 12 is performed). In the basic control in the control device 40, the first irradiation/exposure period is a period that continues over a time shorter than half of the frame processing cycle T.

In the example shown in FIG. 4, at a time t₂ when an offset time ΔT has elapsed from the time t₁, the second camera module 20 receives the irradiation start signal and the exposure start signal from the imaging control unit 431, and the irradiation with the infrared light by the second projector 21 and the exposure in the second camera 22 are started. In the present embodiment, in the basic control in the control device 40, the offset time ΔT is set to a reference offset time ΔTref, which is half of the frame processing cycle T (ΔTref=T/2). Thus, in each occasion of the frame processing, the irradiation with the infrared light by the second projector 21 and the exposure in the second camera 22 are started after the end of the first irradiation/exposure period.

The irradiation with the infrared light by the second projector 21 is performed over the irradiation time included in the irradiation start signal. Similarly, the exposure in the second camera 22 is also performed over the exposure time included in the exposure start signal. In the present embodiment, the imaging control unit 431 simultaneously transmits the irradiation start signal and the exposure start signal (or transmits the signals as one signal for instruction of the start of both) and the irradiation time and the exposure time are the same time. Thus, in the present embodiment, the period in which the irradiation with the infrared light is performed by the second projector 21 and the period in which the exposure in the second camera 22 is performed are the same period, and these periods are collectively referred to as the second irradiation/exposure period hereinafter. The period in which the irradiation with the infrared light is performed by the second projector 21 and the period in which the exposure in the second camera 22 is performed need not be the same period. In the basic control in the control device 40, the irradiation time of the infrared light by the second projector 21 and the exposure time in the second camera 22 are the same time as the irradiation time of the infrared light by the first projector 11 and the exposure time in the first camera 12, respectively. Thus, in the basic control in the control device 40, the second irradiation/exposure period is a period that continues over a time shorter than half of the frame processing cycle T. Thus, in each occasion of the frame processing, the second irradiation/exposure period ends before the end of the frame processing cycle (before a time t₃).

When the image processing unit 432 receives data representing an image captured by the first camera 12 from the first camera 12 via the imaging control unit 431 after imaging by the first camera 12 ends, the image processing unit 432 performs image processing on the image (first image in the drawing) captured by the first camera 12 based on the received image data. Specifically, the first camera 12 performs readout when the exposure in the first camera 12 ends, and transmits image data representing an image obtained by the readout to the image processing unit 432. When the image processing unit 432 receives the image data, the image processing unit 432 performs image processing including detection of the dynamic range in the image captured by the first camera 12. Thus, the image processing unit 432 transmits the value of the dynamic range detected in this way to the imaging control unit 431. In the example shown in FIG. 4, the value of the dynamic range is transmitted to the imaging control unit 431 before the time (time t₃) when next frame processing is started.

Similarly, when the image processing unit 432 receives data representing an image captured by the second camera 22 from the second camera 22, the image processing unit 432 performs image processing on the image (second image in the drawing) captured by the second camera 22. The image processing unit 432 transmits the detected value of the dynamic range to the imaging control unit 431.

In the example shown in FIG. 4, the frame processing as described above is repeated for each frame processing cycle T. Thus, at the time t₃ and a time t₅ when the frame processing cycle T has repeatedly elapsed from the time t₁, a next first irradiation/exposure period is started. At times t₄ and t₆ when the offset time ΔT has elapsed from the first irradiation/exposure period, which is the start timing of the frame processing, the second irradiation/exposure period is started.

In the present embodiment, the frame processing cycle T is a constant time, and the irradiation with the infrared light by the first projector 11 and the exposure in the first camera 12 are started at the start timing of each occasion of the frame processing. Thus, in the present embodiment, the first irradiation/exposure period is started for each frame processing cycle T, that is, at the same time interval. However, the irradiation with the infrared light by the second projector 21 and the exposure in the second camera 22 may be started at the start timing of each occasion of the frame processing. In this case, in each occasion of the frame processing, the first irradiation/exposure period is started after the second irradiation/exposure period is ended.

In addition, in a case where the imaging device 1 includes three or more camera modules, the imaging control unit 431 controls these camera modules in the basic control such that the irradiation/exposure period of each camera module does not overlap the irradiation/exposure period of the other camera modules.

### Control of Period in Control Device

In a case where the basic control as described above is performed, it is necessary to perform the irradiation/exposure in the first camera module 10 and the irradiation/exposure in the second camera module 20 in different periods during one occasion of the frame processing. Thus, when the exposure time of each of cameras 12 and 22 of the respective camera modules is excessively increased, the frame processing cycle T is increased.

On the other hand, when the frame processing cycle T is set short, the exposure time of each of the cameras 12 and 22 becomes short. As a result, depending on an imaging situation, imaging with sufficient exposure cannot be performed, and the quality of the captured image may be deteriorated.

Here, the image captured by the first camera 12 of the first camera module 10 is used to detect a face direction, a line-of-sight direction, an open/closed state of the eyes, and the like of a driver of a vehicle 100 and determine whether there is inattentiveness or drowsiness of the driver. On the other hand, the image captured by the second camera 22 of the second camera module 20 is used to detect the movement of the hand of the passenger seated on a seat 103 and search for and make a notification of the store present in a direction that the passenger is pointing. As described above, the first camera module 10 and the second camera module 20 may be used for functions different from each other. In the present embodiment, the image captured by the first camera 12 of the first camera module 10 is used for a function related to safety of the passenger more than the image captured by the second camera 22 of the second camera module 20 is. Thus, it can be said that the image captured by the first camera 12 has a higher acquisition priority than the image captured by the second camera 22.

Even when the use of the image captured by each camera is different from the use in the present embodiment, the acquisition priorities are different from each other when the uses of the images captured by the cameras are different from each other. For example, in a case where the image captured by the first camera 12 is used to detect the fastening/unfastening state of the seat belt of the passenger and the image captured by the second camera 22 is used to search for and make the notification of the store present in the direction that the passenger is pointing, the image captured by the first camera 12 is used for a function related to the safety of the passenger and thus has the higher acquisition priority. In addition, in a case where the image captured by the first camera 12 is used for current control of the vehicle 100 and the image captured by the second camera 22 is used for collecting traveling data, the image captured by the first camera 12 is directly connected to the current control of the vehicle 100 and thus has the higher acquisition priority.

Thus, in the present embodiment, the imaging control unit 431 controls the first camera module 10 and the second camera module 20 in each occasion of the frame processing (that is, in a unit imaging cycle) such that the first irradiation/exposure period is changed based on the value of the dynamic range in the image captured by the first camera 12, detected by the image processing unit 432.

In particular, in the present embodiment, the imaging control unit 431 controls the first camera module 10 and the second camera module 20 in each occasion of the frame processing such that the first irradiation/exposure period related to the first camera 12 having a higher imaging priority of an image is equal to or greater than the second irradiation/exposure period related to the second camera 22 having a lower imaging priority of an image.

More specifically, the imaging control unit 431 controls the first camera module 10 and the second camera module 20 such that when the value of the dynamic range is low in the image captured by the first camera 12 in the previous frame processing, the first irradiation/exposure period is made correspondingly longer than the second irradiation/exposure period. In other words, the imaging control unit 431 controls the first camera module 10 and the second camera module 20 such that when the value of the parameter (first parameter) that changes according to the ease of recognition of an object in the image captured by the first camera 12 indicates high difficulty in recognizing the object in the image, the first irradiation/exposure period is made correspondingly longer than the second irradiation/exposure period. Further, when the value of the dynamic range is lower than the predetermined second reference value and is very low (that is, when the value of the parameter that changes according to the ease of recognition of an object in the image captured by the first camera 12 indicates that the ease of recognition of an object in the image is equal to or less than a predetermined first reference ease of recognition), the imaging control unit 431 sets the first irradiation/exposure period long and cancels the irradiation with the infrared light by the second projector 21 and the exposure in the second camera 22 (that is, sets the second irradiation/exposure period to zero).

As described above, in the imaging device 1 in the present embodiment, the first irradiation/exposure period and the second irradiation/exposure period are changed based on the dynamic range in the image captured by the first camera 12. Thus, in the imaging device 1, the irradiation/exposure time can be changed according to the ease of recognition of an object in the image captured by the first camera 12 having the higher acquisition priority. As a result, when the value of the dynamic range is large, that is, when the object in the image captured by the first camera 12 having the higher acquisition priority is easily recognized, the irradiation time by the first projector 11 and the exposure time in the first camera 12 can be relatively set short, and imaging with sufficient exposure for recognition of the object can be performed while setting the imaging time short.

In particular, in the present embodiment, the first irradiation/exposure period is longer than the second irradiation/exposure period. As a result, since the irradiation time and the exposure time can be set long for the first camera module 10 having the higher acquisition priority of the image, imaging with sufficient exposure can be performed, and the irradiation time and the exposure time can be set short for the second camera module 20 having the lower image acquisition priority, and thus the lengthening of the frame processing cycle T can be suppressed.

Furthermore, in the present embodiment, when the object in the image captured by the first camera 12 is difficult to be recognized, the irradiation time and the exposure time in the first camera module 10 is made relatively longer, and thus the object becomes easy to be recognized in the image captured by the first camera 12 having the higher acquisition priority. In particular, in the present embodiment, when the object in the image captured by the first camera 12 is difficult to be recognized, the irradiation with the infrared light by the second projector 21 and the exposure in the second camera 22 are canceled. Thus, the first irradiation/exposure period can be made as long as possible, and thus, the object becomes easy to be recognized in the image captured by the first camera 12 having the higher acquisition priority.

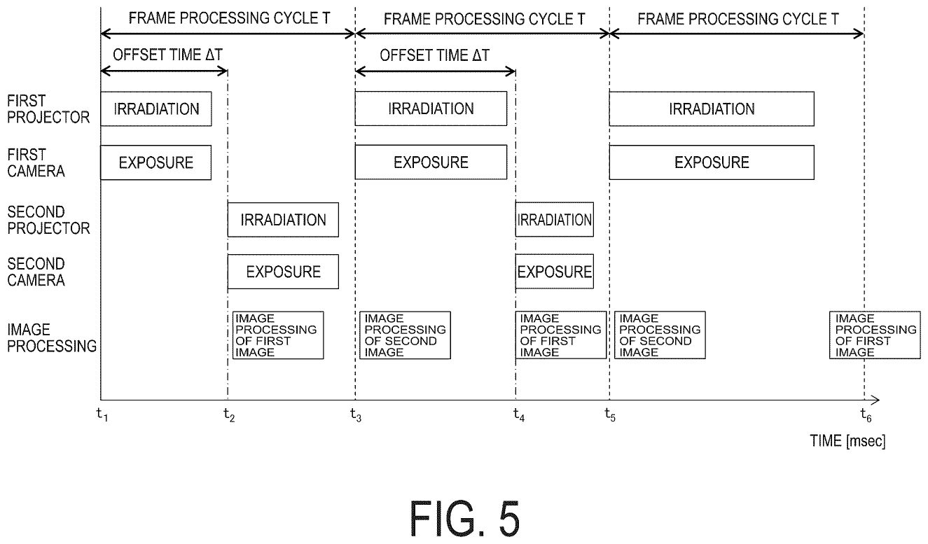

FIG. 5 is a time chart, similar to FIG. 4, showing the irradiation timing of the infrared light in the first projector 11, and the like, of the control of the irradiation/exposure period according to the first embodiment.

As illustrated in FIG. 5, even when the control of the irradiation/exposure period is performed, the frame processing is performed at an arbitrary frame processing cycle T (for example, several tens [ms] to several hundreds [ms]), and thus imaging by the camera modules 10 and 20 is performed at every frame processing cycle T. In particular, in the present embodiment, even when the control of the irradiation/exposure period is performed, at the time t₁, which is the start timing of the frame processing, the first camera module 10 receives the irradiation start signal and the exposure start signal from the imaging control unit 431, and the irradiation with the infrared light by the first projector 11 and the exposure in the first camera 12 are started. As described above, in the present embodiment, regardless of whether the irradiation/exposure period is controlled, that is, regardless of the lengths of the first irradiation/exposure period and the second irradiation/exposure period, by setting the frame processing cycle T constant, and by setting the time interval of the irradiation with the infrared light by the first projector 11 and the start of the exposure in the first camera constant, complication of the control of the first camera module 10 and the second camera module 20 can be suppressed.

In the example shown in FIG. 5, similarly to the example shown in FIG. 4, a value Dr of the dynamic range in the image captured by the first camera 12 is transmitted to the imaging control unit 431 by the time t₃. The example shown in FIG. 5 shows a case where the value Dr of the dynamic range is a value lower than a first reference value Dr1. In this case, in the present embodiment, the imaging control unit 431 sets the first irradiation/exposure period long and sets the second irradiation/exposure period short in the frame processing starting from the time t₃. In particular, in the present embodiment, the second irradiation/exposure period is set short by the amount by which the first irradiation/exposure period becomes long. As a result, also in the frame processing starting from the time t₃, the length of the entire irradiation/exposure period including the first irradiation/exposure period and the second irradiation/exposure period is maintained constant. In addition, in the present embodiment, the offset time ΔT also becomes long by the amount by which the first irradiation/exposure period becomes long.

Further, in the example shown in FIG. 5, the value Dr of the dynamic range in the image captured by the first camera 12 in the frame processing from the time t₃ to a time t₅ is transmitted to the imaging control unit 431 by the time t₅. The example shown in FIG. 5 shows a case where the value Dr of the dynamic range is lower than a second reference value Dr2 that is lower than the first reference value Dr1 (Dr2<Dr1). In this case, in the present embodiment, the imaging control unit 431 further sets the first irradiation/exposure period long and cancels the irradiation with the infrared light by the second projector 21 and the exposure in the second camera 22 in the frame processing starting from the time t₅. Thus, in the frame processing starting from the time t₅, only the irradiation with the infrared light by the first projector 11 and the exposure in the first camera 12 are performed. In the present embodiment, in the frame processing starting from the time t₅, the first irradiation/exposure period is a period that continues over a time longer than half of the frame processing cycle T.

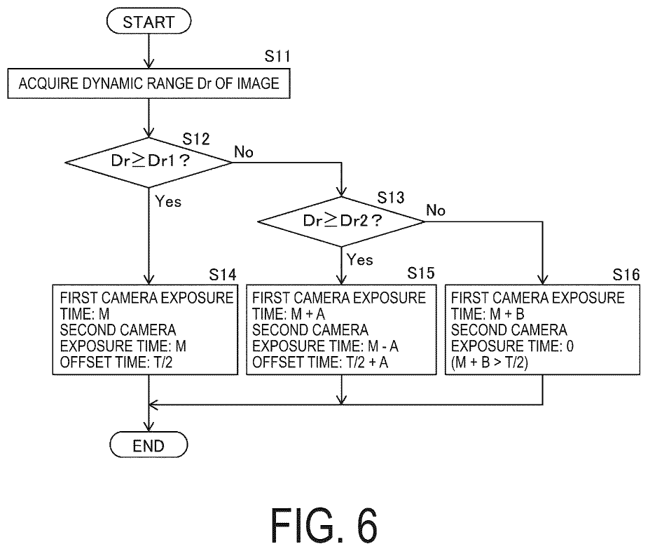

FIG. 6 is a flowchart showing a flow of setting processing of the irradiation/exposure period executed by the imaging control unit 431. The setting processing shown in FIG. 6 is executed by the processor 43 each time the value Dr of the dynamic range in the image captured by the first camera 12 is detected by the image processing unit 432.

As shown in FIG. 6, first, the imaging control unit 431 acquires the value Dr of the dynamic range in an image captured most recently by the first camera 12 from the image processing unit 432 (step S11). Next, the imaging control unit 431 determines if the acquired value Dr of the dynamic range is equal to or greater than the first reference value Dr1, if the acquired value Dr of the dynamic range is lower than the first reference value Dr1 and equal to or greater than the second reference value Dr2, or if the acquired value Dr of the dynamic range is lower than the second reference value Dr2 (steps S12 and S13).

If it is determined that the value Dr of the dynamic range is equal to or greater than the first reference value Dr1 in steps S12 and S13, then the imaging control unit 431 sets the irradiation time of the infrared light by the first projector 11 and the exposure time in the first camera 12 to a reference time M. In addition, the imaging control unit 431 also sets the irradiation time of the infrared light by the second projector 21 and the exposure time in the second camera 22 to the reference time M. Further, the imaging control unit 431 sets the offset time ΔT from the start of the irradiation with the infrared light by the first projector 11 and the exposure in the first camera 12 to the start of the irradiation with the infrared light by the second projector 21 and the exposure in the second camera 22 to half of the frame processing cycle T (T/2) (step S14).

On the other hand, if it is determined that the value Dr of the dynamic range is lower than the first reference value Dr1 and equal to or greater than the second reference value Dr2 in steps S12 and S13, then the imaging control unit 431 sets the irradiation time of the infrared light by the first projector 11 and the exposure time in the first camera 12 to a time (M+A) obtained by adding a first time A to the reference time M. In addition, the imaging control unit 431 sets the irradiation time of the infrared light by the second projector 21 and the exposure time in the second camera 22 to a time (M−A) obtained by subtracting the first time A from the reference time M. The imaging control unit 431 sets the offset time ΔT to a time (T/2+A) obtained by adding the first time A to half of the frame processing cycle T (step S15).

Further, if it is determined that the value Dr of the dynamic range is lower than the second reference value Dr2 in steps S12 and S13, then the imaging control unit 431 sets the irradiation time of the infrared light by the first projector 11 and the exposure time in the first camera 12 to a time (M+B) obtained by adding a second time B (B>A) longer than the first time A to the reference time M (T/2<M+B<T). In addition, the imaging control unit 431 cancels the irradiation with the infrared light by the second projector 21 and the exposure in the second camera 22 (step S16).

If the setting processing of the irradiation/exposure period shown in FIG. 6 is completed, then in the frame processing started thereafter, the imaging control unit 431 controls the first camera module 10 and the second camera module 20 based on the irradiation time, the exposure time, and the offset time set in step S14, S15, or S16.

In the above-described embodiment, the imaging control unit 431 controls the irradiation/exposure period in three stages according to the value Dr of the dynamic range. However, the imaging control unit 431 may control the irradiation/exposure period in two stages or in four or more stages according to the value Dr of the dynamic range. Alternatively, instead of stepwise control, the imaging control unit 431 may linearly control the irradiation/exposure period according to the value Dr of the dynamic range. In the above-described embodiment, when the value Dr of the dynamic range is very low, the irradiation with the infrared light by the second projector 21 and the exposure in the second camera 22 are canceled. However, even when the value Dr of the dynamic range is very low, the irradiation with the infrared light by the second projector 21 and the exposure in the second camera 22 need not be canceled.

The above embodiment shows a case where the imaging device 1 includes two camera modules. However, also in a case where the imaging device 1 includes three or more camera modules, similar control may be performed. In the case where the imaging device 1 includes three camera modules, for example, the irradiation/exposure period in each camera module is set according to the value Dr of the dynamic range in the image captured by the camera having the highest image acquisition priority among the three cameras. In particular, the lower the value Dr of the dynamic range, the longer the irradiation/exposure period is made in the camera module including the camera having the highest image acquisition priority. Alternatively, in the case where the imaging device 1 includes three camera modules, for example, the irradiation/exposure period in each camera module may be set according to the values Dr of the dynamic range in the images captured by two cameras having the higher image acquisition priorities among the three cameras. In this case, the lower the value Dr of the dynamic range in the image captured by the camera having the highest image acquisition priority, the longer the irradiation/exposure period is made in the camera module including the camera having the highest image acquisition priority. In addition, the lower the value Dr of the dynamic range in the image captured by the camera having the second highest image acquisition priority, the longer the irradiation/exposure period is made in the camera module including the camera having the second highest image acquisition priority.

### Second Embodiment

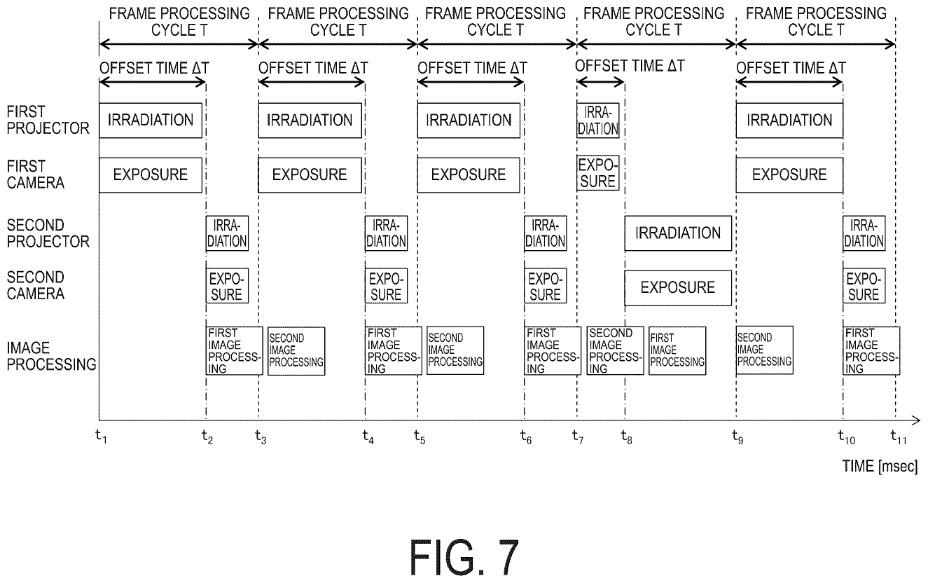

Next, the imaging device 1 according to a second embodiment will be described with reference to FIG. 7. The configuration and control of the imaging device 1 according to the second embodiment are basically the same as the configuration and control of the imaging device 1 according to the first embodiment. Hereinafter, points different from the configuration and control of the imaging device 1 according to the first embodiment will be mainly described.

As described above, in the first embodiment, in the case where the value of the dynamic range in the image captured by the first camera 12 is low, the first irradiation/exposure period is set long, and as a result, the second irradiation/exposure period is set shorter. Thus, when a state in which the value of the dynamic range in the image captured by the first camera 12 is low continues, the state in which the second irradiation/exposure period is short continues.

In addition, when the second irradiation/exposure time is short, the value of the dynamic range in the image captured by the second camera 22 becomes low, and the object in the image becomes difficult to be recognized. Thus, when the state in which the second irradiation/exposure period is short continues, a function of using the image captured by the second camera 22 may not be continuously used.

Thus, in the present embodiment, in a case where the value of the dynamic range in the image captured by the second camera 22 is lower than a predetermined third reference value and is very low (that is, in a case where the value of the parameter (second parameter) that changes according to the ease of recognition of an object in the image captured by the second camera 22 is a value indicating that the ease of recognition of an object in the image is equal to or less than a predetermined second reference ease of recognition), the imaging control unit 431 controls the first camera module 10 and the second camera module 20 such that the second irradiation/exposure period is longer than the first irradiation/exposure period in less than half the number of occasions of the frame processing among consecutive occasions of the frame processing (that is, in a proportion of the imaging cycles less than half among consecutive imaging cycles). In this case, in the present embodiment, for example, in a case where a state in which the value of the dynamic range in the image captured by the second camera 22 is lower than the third reference value continues for several or about a dozen occasions of the frame processing, the second irradiation/exposure period is set longer than the first irradiation/exposure period in one subsequent occasion of frame processing. Thus, the continuation of a state in which it is difficult to recognize an object in the image captured by the second camera 22 is suppressed, preventing the function that uses such an image from being continuously unavailable.

FIG. 7 is a time chart, similar to FIG. 5, of the control of the irradiation/exposure period according to the second embodiment. As illustrated in FIG. 7, in the frame processing starting from the times t₁, t₃, and t₅, the dynamic range in the image captured by the first camera 12 is low, and thus the first irradiation/exposure period is set longer than the second irradiation/exposure period. As a result, the state in which the second irradiation/exposure period is short continues, and the values of the dynamic ranges in the images captured in the second irradiation/exposure periods starting from the times t₂, t₄, and t₆ are values lower than a third reference value Dr3. Thus, in the frame processing starting from the time t₇, the second irradiation/exposure period is set longer than the first irradiation/exposure period. In addition, in the present embodiment, the offset time ΔT also becomes short by the amount by which the first irradiation/exposure period becomes short.

In the example shown in FIG. 7, also in the frame processing starting from the time t₇, the irradiation with the infrared light by the first projector 11 and the exposure in the first camera 12 are performed. However, in the frame processing starting from the time t₇, the irradiation with the infrared light by the first projector 11 and the exposure in the first camera 12 may be canceled.

Although the preferred embodiments according to the present disclosure have been described above, the present disclosure is not limited to these embodiments, and various modifications and changes can be made within the scope of the claims.

1. An imaging device configured to perform imaging, comprising:
a first camera and a second camera each having sensitivity to invisible light;
a first irradiation unit configured to irradiate an imaging range of the first camera with the invisible light during an exposure period in the first camera;
a second irradiation unit configured to irradiate an imaging range of the second camera with the invisible light during an exposure period in the second camera; and
a processor configured to control the first camera, the second camera, the first irradiation unit, and the second irradiation unit, wherein
an irradiation range of the invisible light by the first irradiation unit at least partially overlaps an irradiation range of the invisible light by the second irradiation unit,
an image captured by the first camera has a higher acquisition priority than an image captured by the second camera, and
the processor is configured to perform control such that, in a unit imaging cycle, a first irradiation/exposure period in which irradiation by the first irradiation unit and exposure by the first camera are performed and a second irradiation/exposure period in which irradiation by the second irradiation unit and exposure by the second camera are performed do not overlap each other, and the first irradiation/exposure period in the unit imaging cycle is changed according to a value of a first parameter that changes according to ease of recognition of an object in the image captured by the first camera.

2. The imaging device according to claim 1, wherein
the processor is configured to perform control such that, in the unit imaging cycle, the first irradiation/exposure period is made equal to or greater than the second irradiation/exposure period according to the value of the first parameter.

3. The imaging device according to claim 2, wherein
the processor is configured to perform control such that as the value of the first parameter indicates higher difficulty in recognizing an object in the image captured by the first camera, the first irradiation/exposure period is made correspondingly longer than the second irradiation/exposure period.

4. The imaging device according to claim 3, wherein
the first parameter is a dynamic range in the image captured by the first camera, and
the processor is configured to perform control such that as the value of the dynamic range is lower, the first irradiation/exposure period is made correspondingly longer than the second irradiation/exposure period.

5. The imaging device according to claim 1, wherein
the processor is configured to perform control such that start of the first irradiation/exposure period is repeated at the same time interval regardless of a change in the first irradiation/exposure period or the second irradiation/exposure period in the unit imaging cycle.

6. The imaging device according to claim 1, wherein
the processor is configured to cancel the exposure in the second camera and the irradiation by the second irradiation unit when the value of the first parameter is a value indicating that the ease of recognition of an object in the image captured by the first camera is equal to or less than a predetermined first ease of recognition.

7. The imaging device according to claim 1, wherein
the processor is configured to perform control such that the second irradiation/exposure period is longer than the first irradiation/exposure period, in a proportion of imaging cycles less than half among consecutive imaging cycles of the first camera and the second camera, when a value of a second parameter that changes according to ease of recognition of an object in the image captured by the second camera is a value indicating that the ease of recognition of an object in the image captured by the second camera is equal to or less than a predetermined second ease of recognition.

8. The imaging device according to claim 1, wherein
the invisible light is infrared light.

9. The imaging device according to claim 1, wherein
the imaging device is equipped on one vehicle.

10. The imaging device according to claim 9, wherein
the image captured by the first camera is used for a function related to safety of a passenger of the vehicle more than the image captured by the second camera is.

11. The imaging device according to claim 9, wherein
the first camera and the second camera are disposed to image the same passenger of the vehicle.

12. An imaging control method for controlling a first camera and a second camera each having sensitivity to invisible light, a first irradiation unit configured to irradiate an imaging range of the first camera with the invisible light during an exposure period in the first camera, and a second irradiation unit configured to irradiate an imaging range of the second camera with the invisible light during an exposure period in the second camera, wherein
an irradiation range of the invisible light by the first irradiation unit at least partially overlaps an irradiation range of the invisible light by the second irradiation unit,
an image captured by the first camera has a higher acquisition priority than an image captured by the second camera, and
the imaging control method comprises controlling the first camera, the second camera, the first irradiation unit, and the second irradiation unit such that, in a unit imaging cycle, a first irradiation/exposure period in which irradiation by the first irradiation unit and exposure by the first camera are performed and a second irradiation/exposure period in which irradiation by the second irradiation unit and exposure by the second camera are performed do not overlap each other, and the first irradiation/exposure period in the unit imaging cycle is changed according to a value of a first parameter that changes according to ease of recognition of an object in the image captured by the first camera.

13. A non-transitory computer-readable medium having recorded thereon an imaging control program configured to control a first camera and a second camera each having sensitivity to invisible light, a first irradiation unit configured to irradiate an imaging range of the first camera with the invisible light during an exposure period in the first camera, and a second irradiation unit configured to irradiate an imaging range of the second camera with the invisible light during an exposure period in the second camera, wherein
an irradiation range of the invisible light by the first irradiation unit at least partially overlaps an irradiation range of the invisible light by the second irradiation unit,
an image captured by the first camera has a higher acquisition priority than an image captured by the second camera, and
the imaging control program causes a computer to execute control of the first camera, the second camera, the first irradiation unit, and the second irradiation unit such that, in a unit imaging cycle, a first irradiation/exposure period in which irradiation by the first irradiation unit and exposure by the first camera are performed and a second irradiation/exposure period in which irradiation by the second irradiation unit and exposure by the second camera are performed do not overlap each other, and the first irradiation/exposure period in the unit imaging cycle is changed according to a value of a first parameter that changes according to ease of recognition of an object in the image captured by the first camera.
